(19) United States
(12) Patent Application Publication
(10) Pub. No.: US 2026/0246287 A1
(43) Pub. Date: Aug. 20, 2026

(54) DETACHABLE AND REPLACEABLE CONNECTOR BASE STRUCTURE FOR LITHIUM-ION POWER TOOL BATTERY PACK

(71) Applicant: Zhejiang Rongpeng Air Tools Co., Ltd., Taizhou (CN)

(72) Inventors: Xiaorong Li, Taizhou (CN); Xiaopeng Li, Taizhou (CN)

(21) Appl. No.: 19/072,901

(22) Filed: Mar. 6, 2025

(30) Foreign Application Priority Data
Feb. 19, 2025 (CN) 202520266129.0

(51) Int. Cl. H02J 7/00

(52) U.S. Cl. CPC H02J 7/751

(57) ABSTRACT

A detachable and replaceable connector base structure for a lithium-ion power tool battery pack, comprising a housing and a circuit board provided at the bottom of the housing; the bottom of the housing is provided with a connector base on which a battery pack is mounted, the connector base is detachably connected to the housing, and a positioning and fixing structure is provided between a side of the connector base and the housing to form a detachable fixed connection between the connector base and the housing; the battery pack is provided with a buckle structure that cooperates with the connector base, and the connector base is further provided with a plurality of conductive inserts. The connector base is detachably connected to the housing of the lithium battery tool in a separable manner, while the battery pack is connected to the housing through the connector base.

### FIELD OF THE INVENTION

The present invention relates to the field of lithium battery tools, and more specifically to a detachable and replaceable connector base structure for a lithium-ion power tool battery pack.

### BACKGROUND OF THE INVENTION

Lithium battery tools are commonly used in daily life. To facilitate operation, most current lithium battery tools are equipped with rechargeable battery packs, making them very convenient to carry and use. However, existing lithium battery tools are delivered from the factory with a dedicated battery pack model; that is, the housing of the lithium battery tool is designed with a dedicated buckle structure for a specific battery pack. This design has certain drawbacks: the tool housings are pre-molded and can only accommodate the corresponding dedicated battery pack, and cannot be adapted at the factory to allow for different battery pack replacements as required by customers. This results in significant inconvenience during production and use.

### SUMMARY OF THE INVENTION

The purpose of the present invention is to solve the problems stated in the background by providing a detachable and replaceable connector base structure for a lithium-ion power tool battery pack.

To achieve the above object, the technical solution of the present invention is as follows:

A detachable and replaceable connector base structure for a lithium-ion power tool battery pack, comprising a housing and a circuit board provided at the bottom of the housing; the bottom of the housing is provided with a connector base on which the battery pack is mounted. The connector base is detachably connected to the housing, and a positioning structure is provided between the side of the connector base and the housing, so as to form a detachable fixed connection between the connector base and the housing. The battery pack is provided with a buckle structure that cooperates with the connector base, and the connector base is further provided with a plurality of conductive inserts.

In the above connector base structure, the positioning structure between the connector base and the housing is arranged on both side surfaces. Specifically, the positioning structure comprises a positioning protrusion and a positioning groove, which are respectively provided on the connector base and the housing. In addition, the bottom of the connector base is provided with an installation groove for mounting the battery pack; the battery pack is connected to the connector base via the installation groove and the buckle structure. The buckle structure comprises a push-type spring latch and a buckle groove, which are respectively provided on the battery pack and the connector base.

In the present invention, the connector base is detachably connected to the housing of the lithium battery tool, and the battery pack is connected to the housing via the connector base. The positioning structure between the connector base and the housing is designed universally. This allows the lithium battery tool to use different connector bases, with each connector base capable of accommodating different battery packs. At the time of factory assembly, various battery pack models can be selected according to customer needs, which greatly facilitates production and use.

### BRIEF DESCRIPTION OF THE DRAWINGS

FIG. 1 is an exploded view of the present invention;

FIG. 2 is a perspective view of the present invention;

FIG. 3 is a perspective view of one half of the housing of the present invention;

FIG. 4 is a perspective view of the connector base of the present invention.

### DETAILED DESCRIPTION OF THE PREFERRED EMBODIMENTS

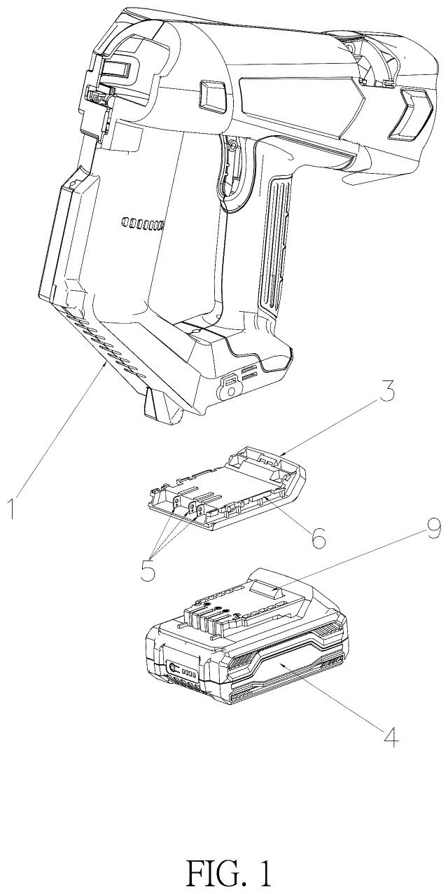

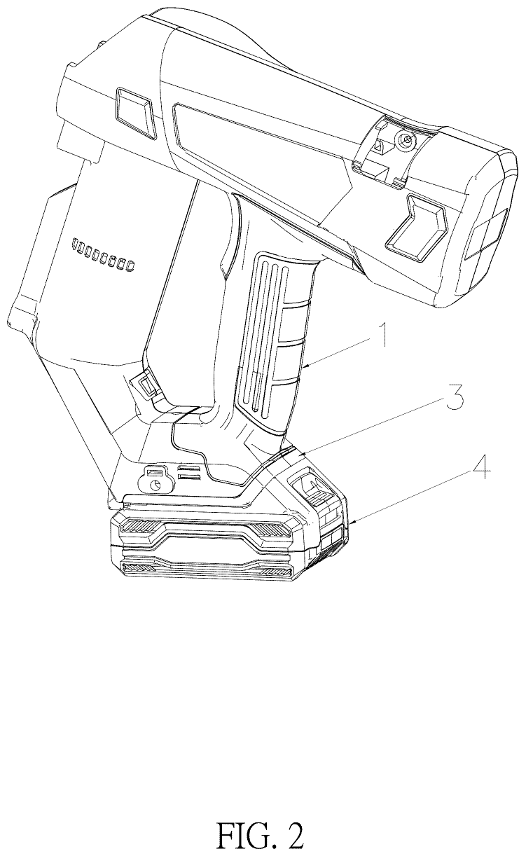

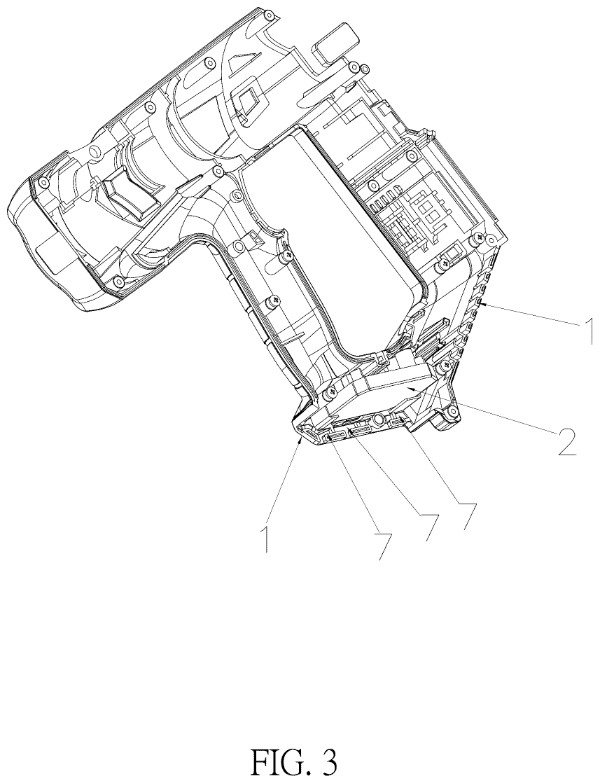

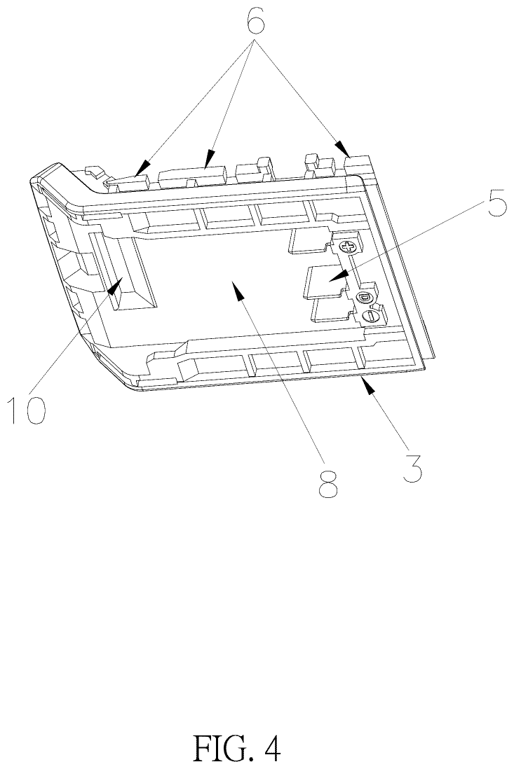

Referring to FIGS. 1 to 4, the present invention provides a detachable and replaceable connector base structure for a lithium-ion power tool battery pack, which includes a housing (1) and a circuit board (2) arranged on the bottom of the housing (1); the bottom of the housing (1) is provided with a connector base (3) on which a battery pack (4) is installed.

The connector base (3) is detachably connected to the housing (1), and a positioning structure is provided between the side of the connector base (3) and the housing (1) so as to form a detachable fixed connection between them. The positioning structure is arranged on both sides; specifically, it comprises a positioning protrusion (6) on the connector base (3) and a positioning groove (7) on the housing (1). The housing (1) is designed in two halves so that during assembly the connector base (3) is secured between the halves of the housing through the corresponding positioning structure. Since the positioning structure between different connector bases and the housing is identical, different connector bases can be chosen at the factory as needed.

The battery pack (4) is provided with a buckle structure that cooperates with the connector base (3). Furthermore, the connector base (3) is equipped with a plurality of conductive inserts (5), which are connected to the circuit board (2) by wiring and welding to establish an electrical connection. The connector base (3) also has an installation groove (8) at its bottom for mounting the battery pack (4), and the battery pack (4) is connected to the connector base (3) via the installation groove (8) and the buckle structure. The installation groove (8) can be designed in various sizes to adapt to battery packs of different models, and the buckle structure comprises a push-type spring latch (9) and a buckle groove (10) provided respectively on the battery pack (4) and the connector base (3). When the battery pack (4) and the connector base (3) are engaged via the buckle structure, the conductive inserts (5) make contact to complete the electrical connection. The buckle structure is conventional and will not be described in further detail. At the time of assembly, different connector bases can be installed to match different battery pack models as required.

The above detailed embodiment of the present invention has been described to illustrate a detachable and replaceable connector base structure for a lithium-ion power tool battery pack. The embodiments provided herein are intended to assist in understanding the technical solution of the present invention and are not meant to limit its scope. Those skilled in the art may make various modifications and changes within the spirit and scope of the present invention.

We claim:

1. A detachable and replaceable connector base structure for a lithium-ion power tool battery pack, comprising:
a housing (1) and a circuit board (2) provided at a bottom of the housing (1);
wherein the bottom of the housing (1) is provided with a connector base (3), a battery pack (4) is mounted on the connector base (3), the connector base (3) is detachably connected to the housing (1), and a positioning structure is provided between a side of the connector base (3) and the housing (1) to form a detachable fixed connection between the connector base (3) and the housing (1);
and wherein the battery pack (4) is provided with a buckle structure that cooperates with the connector base (3), with the connector base (3) further provided with a plurality of conductive inserts (5).

2. The detachable and replaceable connector base structure for a lithium-ion power tool battery pack according to claim 1, wherein the positioning structure between the connector base (3) and the housing (1) is provided on both side surfaces.

3. The detachable and replaceable connector base structure for a lithium-ion power tool battery pack according to claim 1, wherein the positioning structure comprises a positioning protrusion (6) and a positioning groove (7) that are respectively provided on the connector base (3) and the housing (1).

4. The detachable and replaceable connector base structure for a lithium-ion power tool battery pack according to claim 1, wherein an installation groove (8) for mounting the battery pack (4) is provided at a bottom of the connector base (3), and the battery pack (4) is connected to the connector base (3) via the installation groove (8) and the buckle structure.

5. The detachable and replaceable connector base structure for a lithium-ion power tool battery pack according to claim 4, wherein the buckle structure comprises a push-type spring latch (9) and a buckle groove (10) that are respectively provided on the battery pack (4) and the connector base (3).
